(19) United States
(12) Patent Application Publication
(10) Pub. No.: US 2015/0187198 A1
(43) Pub. Date: Jul. 2, 2015

(54) Orientation Measurement And Guidance Of Manually Positioned Objects

(71) Applicants: Aaron G. Silverberg, San Diego, CA (US); Sam Silverberg, Portland, OR (US); Edward S. Silverberg, San Diego, CA (US)

(72) Inventors: Aaron G. Silverberg, San Diego, CA (US); Sam Silverberg, Portland, OR (US); Edward S. Silverberg, San Diego, CA (US)

(21) Appl. No.: 14/142,689

(22) Filed: Dec. 27, 2013

(51) Int. Cl. G08B 21/18

(52) U.S. Cl. CPC G08B 21/182

(57) ABSTRACT

Methods and systems for accurately determining a reference orientation of a hand-held object with respect to a reference surface, measuring subsequent movements with respect to the reference orientation, and providing guidance to a user manipulating the object are described herein. A detection device includes a planar, external surface physically located such that the surface is coplanar with a planar, reference surface, such as a work piece. A repeatable reference orientation is established when the external surface is coplanar with the planar surface of the work piece. Subsequent orientation measurement signals are referenced to this orientation for purposes of determining the orientation of the detection device with respect to the work piece. Furthermore, the detection device is coupled to the hand-held object. In this manner, changes in orientation measured by the detection device are indicative of changes in orientation of the hand-held tool relative to the work piece.

### TECHNICAL FIELD

The described embodiments relate to manually positioned objects, and more particularly to performing measurements of movements of an object manipulated by a user and providing feedback to the user based on the measurements.

### BACKGROUND INFORMATION

When manipulating an object such as a hand-held tool it is often desirable to maintain the tool at a particular orientation with respect to a work piece. For example, when drilling a hole in a piece of material, often it is desirable to maintain the drill bit perpendicular to the work piece at all times during the drilling operation.

Traditional hand-held tools rely on the skill of the operator to maintain the appropriate orientation throughout the cutting operation. However, the results are often disappointing as it is often difficult to visually estimate tool orientation with respect to the work piece with sufficient accuracy. In some examples this leads to tool breakage, work piece damage, or out of tolerance parts. In some cases, it may be unsafe to position the eyes of an operator on the tool during the cutting operation. In some cases, positioning the eyes of an operator on the tool during a cutting operation may result in undesireable fatigue, particularly in a repetitive, production setting.

In some examples, liquid filled bubble levels are employed to provide a measure of tool orientation during operation. Unfortunately, such levels establish the orientation of the tool with respect to the earth's gravitational field. Thus, in situations where cutting operations are to be performed at arbitrary angles with respect to the gravitational field, such bubble level devices either provide no useful measurement feedback, or require complex mechanical structures to reposition the bubble level with respect to the tool at an orientation determined by the user. In some cases, the repositioning of the bubble level with respect to the tool by the user is performed with limited accuracy, leading to unsatisfactory cutting results.

In another example, an orientation sensor is incorporated into a hand-held power tool. Such a device is described in U.S. Pat. No. 7,182,148 to William Szieff. However, in this example, the determination of a reference orientation is based on an arbitrary manipulation of the tool by the user. Hence, this manipulation is performed with limited accuracy, potentially leading to unsatisfactory cutting results.

Improvements to systems for measuring the orientation of a hand-held object with respect to a reference surface and communicating an indication of the orientation to a user during manipulation are desired.

### SUMMARY

Methods and systems for accurately determining a reference orientation of a hand-held object such as a hand-held tool with respect to a reference surface, measuring the orientation of the object with respect to the reference orientation, and communicating an indication of the orientation to a user during manipulation of the object are described herein. In some embodiments, the hand-held object is a hand-held tool such as a hand-held drill, a hand-held thread tapping tool, a circular saw, an oscillating saw, etc. In some other examples, the hand-held object is an element of an assembly to be manually fit to the assembly.

In one aspect, a detection device includes a planar, external surface that can be physically located such that the planar, external surface is coplanar with a planar surface of a reference surface, such as a work piece. When the external surface is coplanar with the planar surface of the work piece, an input device generates a signal indicating that the detection device is in a reference orientation. In some embodiments, the input device is a mechanical switch activated by a user. In some embodiments, the input device includes one or more proximity sensors embedded in the planar, external surface.

A computing system receives a signal from the input device indicating that the planar, external surface is coplanar with the planar surface of the work piece. The computing system treats this as a reference orientation. Subsequent orientation measurement signals are referenced to this orientation for purposes of determining the orientation of the detection device with respect to the work piece.

The computing system is further configured to determine the orientation of a hand-held object coupled to the detection device with respect to the work piece. In one example, detection device is removed from a work piece where the reference orientation has been established and located in a fixed position with respect to a hand-held tool. In this manner, changes in orientation measured by the detection device are indicative of changes in orientation of the hand-held tool relative to the work piece.

In some examples, the computing system is further configured to determine a desired orientation of the hand-held tool relative to the work piece based on the reference orientation. Moreover, the computing system is further configured to determine deviations of the orientation of the hand-held tool from the desired orientation to provide guidance to a user manipulating the hand-held tool.

In some embodiments, a display device is configured to communicate the determined deviations to a user manipulating the hand-held tool. In one embodiment, the display device is an LCD screen that renders directional indicators (e.g., arrows) to a user indicating corrective actions a user should take to reorient the hand-held tool to reach the desired orientation (e.g., perpendicular to the work piece surface). In another embodiment, the display device is a head up display (HUD). Such a display allows users to keep their eyes on the interaction between the tool and the work piece while receiving indications of orientation errors from the HUD. In this manner, a user does not have to shift attention from the interaction between the tool and the work piece to read the visual cues offered by the display device.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a simplified diagram illustrative of one embodiment of a system 100 for determining a reference orientation of an object with respect to a reference surface, measuring deviations from a desired orientation of the object with respect to the reference surface, and communicating the deviations to a user during manipulation of the object.

FIG. 2 is a simplified diagram illustrative of one embodiment of a hand held drill 202 including elements configured for determining a reference orientation of the drill with respect to a work piece, measuring deviations from a desired orientation of the drill with respect to the reference orientation, and communicating the deviations to a user during operation.

FIG. 3 is a simplified diagram illustrative of hand-held drill 202 oriented in a desired orientation with respect to work piece 201.

FIG. 4 is a simplified diagram illustrative of a detachable device configured to determine a reference orientation with respect to a work piece, measuring deviations from a desired orientation of the drill with respect to the reference orientation, and communicating the deviations to a user during operation.

FIG. 5 is a simplified diagram illustrative of a hand-held drill 302 oriented in an ideal orientation with respect to work piece 301.

FIG. 6 is a diagram illustrative of a display 140 in one embodiment.

FIG. 7 is a flowchart illustrative of an exemplary method 400 useful for determining a reference orientation of a hand-held tool with respect to a work piece, measuring deviations from a desired orientation of the tool with respect to the reference orientation, and communicating the deviations to a user during operation.

### DETAILED DESCRIPTION

Reference will now be made in detail to background examples and some embodiments of the invention, examples of which are illustrated in the accompanying drawings.

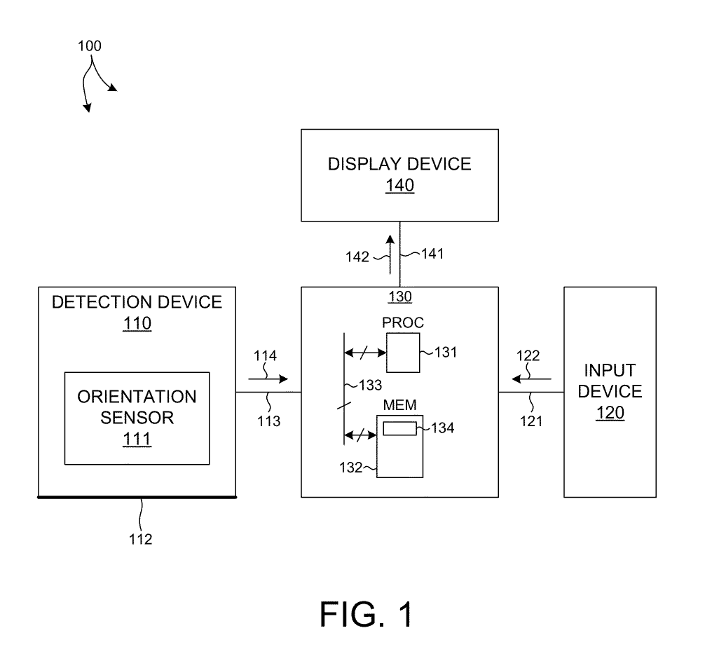

FIG. 1 depicts a system 100 for determining a reference orientation of a hand-held object with respect to a reference surface in a repeatable manner, measuring the orientation of the object with respect to the reference orientation, and communicating an indication of the orientation to a user during manipulation of the object. In some examples, the object is a hand-held tool such as a hand-held drill, a hand-held thread tapping tool, a circular saw, an oscillating saw, etc. In some other examples, the hand-held object is an element of an assembly to be manually fit to the assembly.

System 100 includes a detection device 110 that includes an orientation sensor 111 and a planar, exterior surface 112. Orientation sensor 111 is configured to generate a signal 114 indicative of changes in orientation of the detection device 110. Detection device 110 is communicatively coupled to a computing system 130 by a communication medium 113. Computing system 130 is also communicatively coupled to an input device 120 by a communication medium 121. Input device 120 is configured to generate a signal 122 indicating that the planar, exterior surface 112 of the detection device 110 is oriented coplanar with a planar surface of a reference surface, such as a work piece, at a reference orientation. Computing system 130 is also communicatively coupled to a display device 140 by a communication medium 142. Computing system 130 is further configured to receive signal 122 from input device 120 and receive signal 114 from detection device 110. Based at least in part on these two signals, computing system 130 generates signal 142 indicative of the orientation of the detection device 110 relative to the reference orientation. Display device 140 is configured to receive signal 142 and communicate an indication of the orientation of the detection device relative to the reference orientation to a user based on signal 142.

Orientation sensor 111 may be any sensor suitable for measuring changes in orientation of the detection device 110 in inertial space. Exemplary sensors include an accelerometer, a microelectromechanical system (MEMS) based gyroscope, a global positioning system (GPS) based sensor, a local positioning system based sensor, etc. In general, any sensor operable to detect changes in orientation of detection device 110 may be contemplated.

In one aspect, detection device 110 includes a planar, external surface 112 that can be physically located such that the planar, external surface 112 is coplanar with a planar surface of a reference surface, such as a work piece. When the external surface 112 is coplanar with the planar surface of the work piece, input device 120 generates a signal 122 indicating that detection device 110 is in a reference orientation. In some embodiments, input device 120 is a mechanical switch activated by a user (e.g., a user presses a button that changes the state of the switch to indicate that surface 112 of detection device 110 is coplanar with a surface of the work piece). In some embodiments, input device 120 is one or more proximity sensors embedded in surface 112. The proximity sensors are configured to change state when they are in close proximity to the planar surface of the work piece.

In response to receiving a signal 122 from input device 120 indicating that surface 112 is coplanar with the planar surface of the work piece, computing system 130 receives a measurement signal 114 from detection device 110. In some embodiments, the measurement signal 114 received at this time is treated as a reference orientation signal. Subsequent measurement signals 114 received by processor 130 are further processed with reference to the reference measurement signal for purposes of determining the orientation of detection device 110 with respect to the reference orientation. In one example, the orientation of detection device 110 relative to the reference orientation is determined by subtracting the reference orientation signal from the current orientation signal.

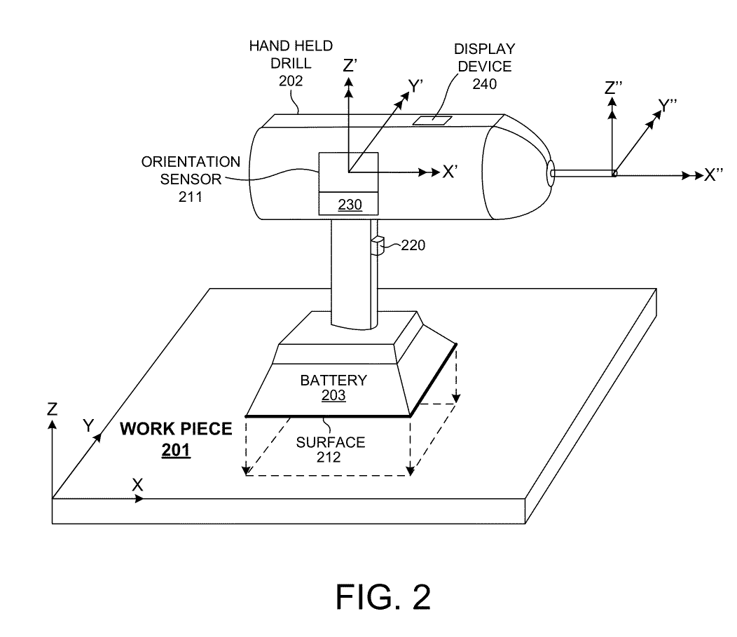

Computing system 130 is further configured to determine the orientation of an object coupled to detection device 110 with respect to the reference orientation. In one example, detection device 110 is removed from a work piece where the reference orientation has been established and located in a fixed position with respect to a hand-held tool. In some examples, computing system 130 determines the orientation of the hand-held tool relative to the work piece based on the measured orientation of detection device 110 with respect to the reference orientation and an appropriate coordinate transformation. The coordinate transformation transforms the orientation measured by the detection device 110 from a coordinate frame fixed to the detection device itself (e.g., coordinate frame X′Y′Z′ depicted in FIG. 2) to a coordinate frame fixed to the tool interacting with the work piece (e.g., coordinate frame X″Y″Z″ depicted in FIG. 2). In general, the coordinate transformation depends on the geometry of external, planar surface 112, the location of detector device 110 on the hand-held tool, and the geometry of the hand-held tool. In this manner, the changes in orientation measured by detection device 110 are indicative of changes in orientation of the hand-held tool relative to the work piece.

In some examples, computing system 130 is further configured to determine a desired orientation of the hand-held tool relative to the work piece as measured by the detection device based on the reference orientation of detection device 110 and an appropriate coordinate transformation. The transformation is determined based on the geometry of external, planar surface 112, the location of detector device 110 on the hand-held tool, the geometry of the hand-held tool, and the desired orientation of the tool itself with respect to the workpiece. The desired orientation of the hand-held tool relative to the work piece as measured by the detection device is determined by applying the coordinate transformation to the reference orientation measured by the detection device 110.

In some examples, computing system 130 is further configured to determine deviations of the orientation of the hand-held tool from the desired orientation by determining a difference between the desired orientation of the hand-held tool relative to the work piece and the measured orientation of the hand-held tool relative to the work piece. Furthermore, computing system 130 generates signal 142 based on the determined deviation.

Display device 140 is configured to receive signal 142 and communicate an indication of the determined deviation to a user of the hand-held tool. In one embodiment, display device is an LCD screen that renders directional indicators (e.g., arrows) to a user indicating corrective actions a user should take to reorient the hand-held tool to reach the desired orientation (e.g., perpendicular to the work piece surface).

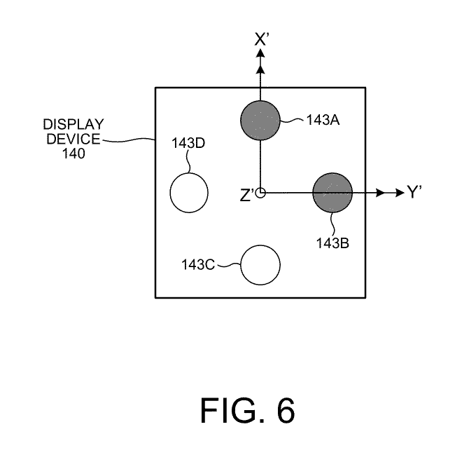

In one embodiment illustrated in FIG. 6, display 140 includes a number of LED arrays 143A-143D. Each LED array is operable to selectively emit different colored light. For example, each LED array may be configured to emit green light when deviations are within a small tolerance band (e.g., within two degrees of the desired orientation), emit yellow light when deviations are within a middle range tolerance band (e.g., between two degrees and five degrees of the desired orientation, and emit red light when deviations exceed the middle range tolerance band (e.g., deviations exceed five degrees from the desired orientation). The display device depicted in FIG. 6 includes four LED arrays to indicate the magnitude of deviations associated with two directions of two orthogonal axes. For example, as depicted in FIG. 6, LED array 143A indicates deviations from the desired orientation in the negative R_{y} direction, while LED array 143C indicates deviations from the desired orientation in the positive R_{y} direction. In this manner, the user is cued not only to the magnitude of the deviation (based on the color of light emitted by the LED array), but also the direction of the deviation (based on which LED array is illuminated). In this manner, the user can take appropriate corrective action to bring the hand-held tool closer to the ideal orientation during tool operation.

In general any number of different combinations of light emitting devices may be employed to indicate the magnitude and direction of orientation errors.

In another embodiment, display device 140 could be a head up display (HUD). Such a display allows users to keep their eyes on the interaction between the tool and the work piece while receiving indications of orientation errors from the HUD. In this manner, a user does not have to shift attention from the interaction between the tool and the work piece to read the visual cues offered by display device 140. Examples of suitable HUD devices include head mounted display devices such as Google Glass™, manufactured by Google Inc., Mountain View, Calif. (USA).

In general, display device 140 could be any device suitable for communicating deviations from the ideal orientation. In some alternative embodiments, an audio device may be employed, alternatively, or in combination with display device 140. By way of non-limiting example, a sequence of audible tones may be generated by the audio device to indicate deviations to the user.

FIG. 2 is a diagram illustrative of a hand held drill 202 including elements configured for determining a reference orientation of the tool with respect to a work piece, measuring deviations from a desired orientation, and communicating the deviations to a user during operation in one embodiment.

In the embodiment depicted in FIG. 2, a hand-held drill 202 includes a computing system 230 communicatively coupled to an orientation sensor 211, a push-button switch 220, and a display device 240 attached to the hand-held drill 202. In the depicted embodiment, hand-held drill 202 includes a battery pack 203 with a planar, external surface 212. In the embodiment depicted in FIG. 2, a user brings surface 212 of the battery pack attached to hand-held drill 202 into contact with a planar surface of work piece 201 such that surface 212 is coplanar with the planar surface of work piece 201. While in this position, a user depresses push-button switch 220. In response push-button switch 220 generates a signal indicating that surface 212 attached to drill 202 is in a reference orientation with respect to work piece 201. In response, computing system 230 receives a measurement signal from orientation sensor 211 that establishes one or more measurement values associated with the angular relationship between a coordinate frame XYZ attached to work piece 201 and a coordinate frame X′Y′Z′ attached to orientation sensor 211 at a well-defined, repeatable reference orientation. In other words, a human operator is able to repeatedly establish the angular relationship between work piece 201 and orientation sensor 211 with high accuracy by locating surface 212 coplanar with the planar surface of work piece 201.

In one example, the one or more measurement values are subtracted from subsequent measurement signals received from orientation sensor 211 by processor 230 to determine the orientation of hand-held drill 202 with respect to the work piece 201.

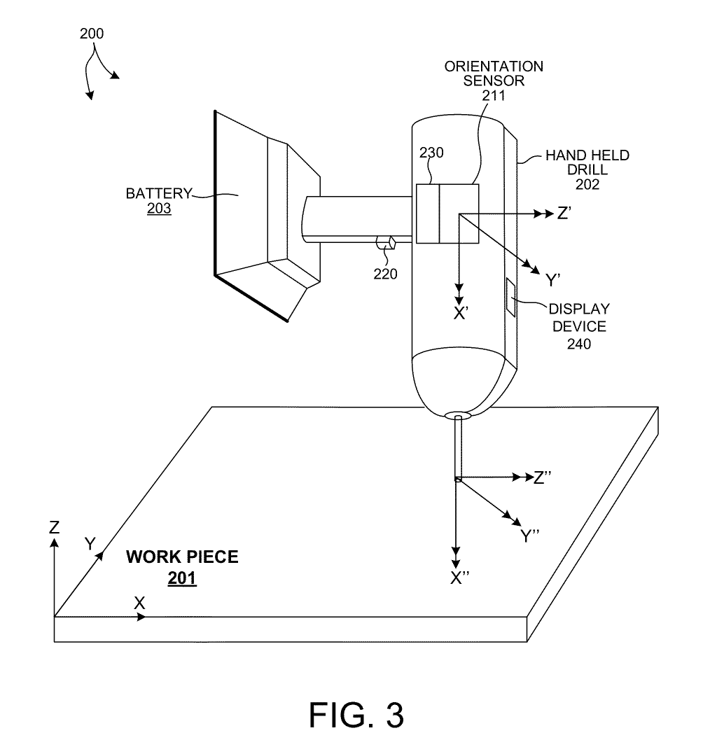

FIG. 3 illustrates hand-held drill 202 oriented in a desired orientation with respect to work piece 201 to drill a hole perpendicular through the planar surface of work piece 201. Computing system 230 is configured to determine a desired orientation of the drill 202 relative to the work piece 201 based on the reference orientation of drill 202 and an appropriate coordinate transformation. During tool operation, orientation sensor 211 attached to drill 202 measures changes in orientation of the drill. Computing system 230 determines deviations of the orientation of the drill 202 from the desired orientation by determining a difference between the desired orientation of the drill relative to the work piece and the measured orientation of the drill relative to the work piece. Computing system 230 generates a signal indicating the determined deviation and LCD display 240 presents a graphical indication of the deviation that is visible to the user.

In the embodiment depicted in FIG. 2, planar, external surface 212 is the bottom facing surface of battery pack 203. However, in general any flat surface of hand-held drill 202 may serve as the surface placed in contact with the work piece to establish the reference orientation.

In another embodiment, any of computing system 230, display device 240, input device 220, and orientation sensor 211 are included as part of the battery pack 203. For example, it may be advantageous to collocate computing system 230 and orientation sensor 211 with the battery pack as the battery pack 203 is a convenient power source for these devices. In another example, input device 220 includes one or more contact sensors or proximity sensors located on surface 212 of battery pack 203. In this manner, the sensors themselves determine when surface 212 is coplanar with the planar surface of work piece 201 without a user having to explicitly provide the indication (e.g., press a button).

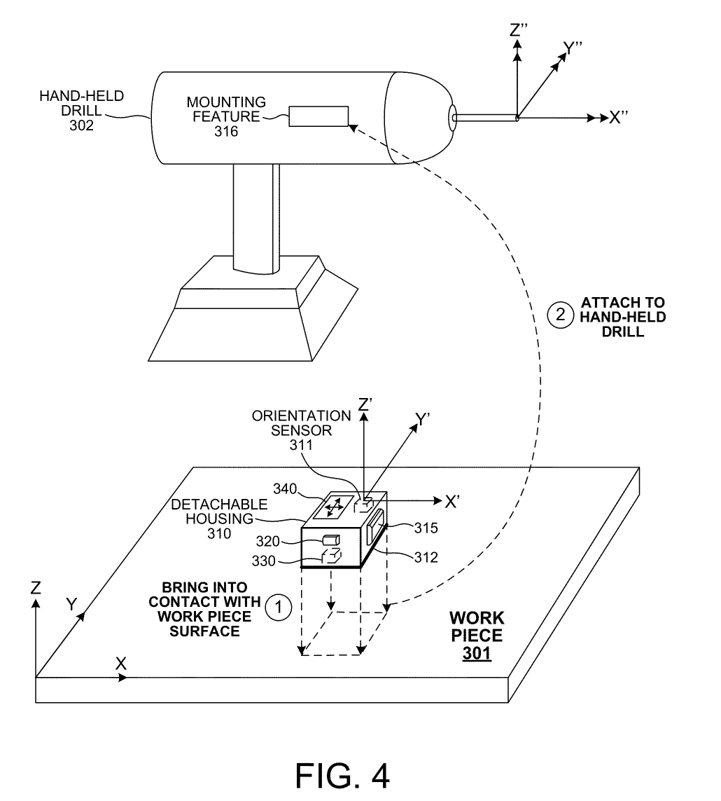

FIG. 4 is a diagram illustrative of an embodiment of a detachable device configured to determine a reference orientation with respect to a work piece, measuring deviations from a desired orientation of a hand-held tool with respect to the reference orientation, and communicating the deviations to a user during operation.

As depicted in FIG. 4, detachable housing 310 includes a planar, exterior surface 312 and a mounting feature 315 that mates with a complementary mounting feature 316 fixed to hand-held drill 302. In this manner, detachable housing 310 may be selectively attached and detached from drill 302.

In a further aspect, detachable housing 310 also includes orientation sensor 311, a computing system 330, display device 340, and input device 320. In the embodiment depicted in FIG. 4, a user brings detachable housing 310 into contact with a planar surface of work piece 301 such that surface 312 and the surface of work piece 301 are coplanar. While in this position, a user depresses push-button switch 320. In response push-button switch 320 generates a signal indicating that surface 312 is in a reference orientation with respect to work piece 301. In response, computing system 330 receives a measurement signal from orientation sensor 311 that establishes one or more measurement values associated with a known angular relationship between a coordinate frame XYZ attached to work piece 301 and a coordinate frame X′Y′Z′ attached to orientation sensor 311.

A user then attaches detachable housing 310 to drill 302 by mating mounting feature 315 with mounting feature 316. The orientation of detachable housing 310 with respect to drill 302 is known a priori. Thus, the orientation of coordinate frame X′Y′Z′ attached to detachable housing 310 is related to a coordinate frame X″Y″Z″ attached to drill 302 by a known, static transformation. In this manner, the orientation of detachable housing 310 is used to determine the orientation of drill 302.

In one example, one or more measurement values generated by orientation sensor 311 are subtracted from subsequent measurement signals received from orientation sensor 311 by processor 330 to determine the orientation of hand-held drill 302 with respect to the work piece 301.

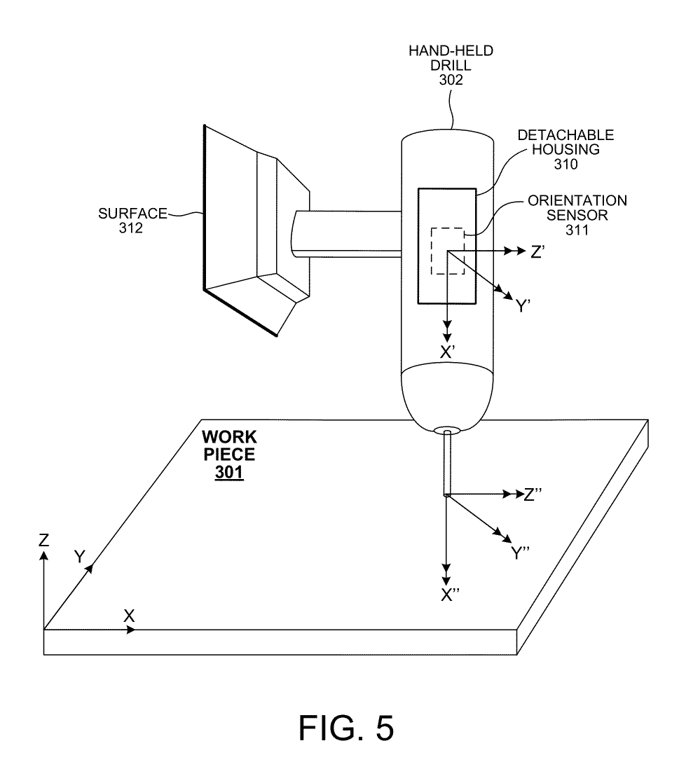

FIG. 5 illustrates hand-held drill 302 oriented in a desired orientation with respect to work piece 301 to drill a hole perpendicular through the planar surface of work piece 301. Computing system 330 is configured to determine a desired orientation of the drill 302 relative to the work piece 301 based on the reference orientation of detachable housing 310 and an appropriate coordinate transformation. During tool operation, orientation sensor 311 attached to drill 302 measures changes in orientation of the drill 302. Computing system 330 determines deviations of the orientation of the drill 302 from the desired orientation by determining a difference between the desired orientation of the drill relative to the work piece and the measured orientation of the drill relative to the work piece. Computing system 330 generates a signal indicating the determined deviation and LCD display 340 presents a graphical indication of the deviation that is visible to the user.

Although the embodiments depicted in FIGS. 2-5 illustrate a hand-held drill, in general, any hand-held tool may be contemplated. In some examples, any of a saw, a hand-held tapping tool, etc. may be similarly configured.

It should be recognized that the various steps described throughout the present disclosure may be carried out by a single computer system or, alternatively, a multiple computer system. Moreover, different subsystems of the system, such as the orientation sensor, may include a computer system suitable for carrying out at least a portion of the steps described herein. Therefore, the aforementioned description should not be interpreted as a limitation on the present invention but merely an illustration.

In addition, the computer system described herein may be communicatively coupled to any other subsystem (e.g., a display device, an orientation sensor, an input device, etc.) in any manner known in the art. For example, the one or more computing systems may be coupled to computing systems associated with the display device and orientation sensor. In another example, any of the input device, orientation sensor, and display device may be controlled directly by a single computer system.

The computer system may be configured to receive and/or acquire data or information from the subsystems of the system (e.g., input device, orientation sensor, and the like) by a transmission medium that may include wireline and/or wireless portions. In this manner, the transmission medium may serve as a data link between the computer system and other subsystems of the system.

By way of non-limiting example, computing system 130 may include, but is not limited to, a microcontroller, microcomputer, or any other device known in the art. In general, the term “computing system” may be broadly defined to encompass any device having one or more processors, which execute instructions from a memory medium.

Program instructions 134 implementing methods such as those described herein may be transmitted over a transmission medium such as a wire, cable, or wireless transmission link. For example, as illustrated in FIG. 1, program instructions stored in memory 132 are transmitted to processor 131 over bus 133. Program instructions 134 are stored in a computer readable medium (e.g., memory 132). Exemplary computer-readable media include read-only memory, a random access memory, a magnetic or optical disk, or a magnetic tape.

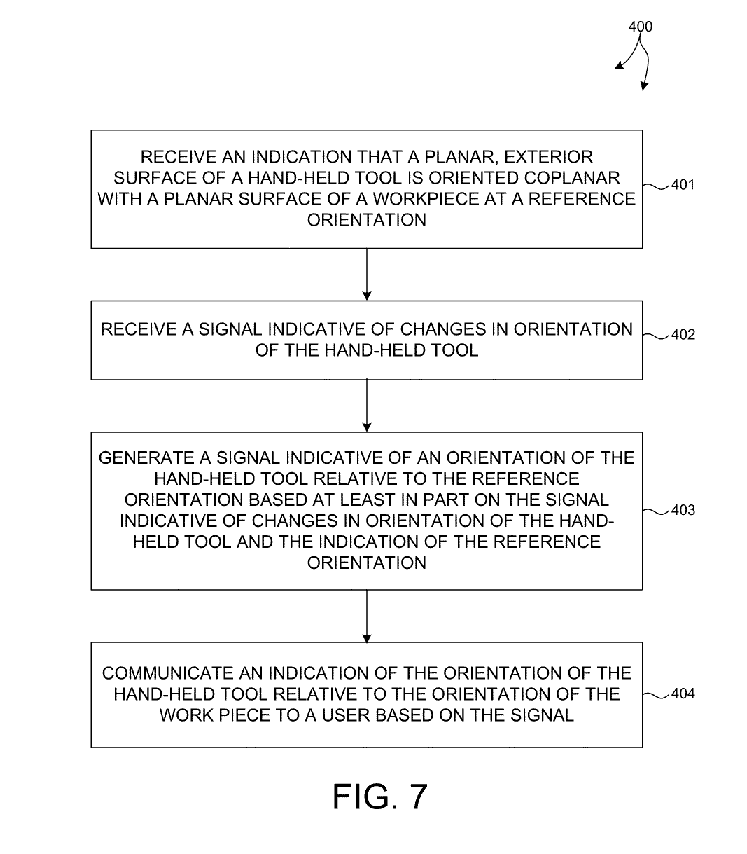

FIG. 7 illustrates a flowchart of an exemplary method 400 useful for determining a reference orientation of a hand-held tool with respect to a work piece with high repeatability and providing orientation guidance to a user of the hand-held tool based on the orientation of the hand-held tool with respect to the reference orientation. In one non-limiting example, system 100, described with reference to FIG. 1 is configured to implement method 400. In one aspect, it is recognized that data processing blocks of method 400 may be carried out via a pre-programmed algorithm executed by one or more processors of computing system 130. However, in general, the implementation of method 400 is not limited by the specific embodiments described herein.

In block 401, a computing system receives an indication that a planar, exterior surface of a hand-held tool is oriented coplanar with a planar surface of a work piece at a reference orientation.

In block 402, the computing system receives a signal indicative of changes in orientation of the hand-held tool.

In block 403, the computing system generates a signal indicative of an orientation of the hand-held tool relative to the reference orientation based at least in part on the signal indicative of changes in orientation of the hand-held tool and the indication of the reference orientation.

In block 404, a display device communicates an indication of the orientation of the hand-held tool relative to the orientation of the work piece to a user based on the signal.

In one or more exemplary embodiments, the functions described may be implemented in hardware, software, firmware, or any combination thereof. If implemented in software, the functions may be stored on or transmitted over as one of more instructions or code on a computer-readable medium. Computer-readable medium includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM of other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

1. An apparatus comprising:
a planar, exterior surface;
an input device configured to generate an indication that the planar, exterior surface is oriented coplanar with a planar surface of a work piece at a reference orientation;
an orientation sensing device configured to generate a signal indicative of changes in orientation of a hand-held object manipulated by a user, wherein the planar, exterior surface is coupled to the hand-held object;
a processor configured to:
receive the indication of the reference orientation from the input device;
determine a desired orientation of the hand-held object relative to the work piece that is different from the reference orientation by applying a coordinate transformation to the indication of the reference orientation;
receive the signal indicative of changes in orientation of the hand-held object; and
generate a signal indicative of a deviation of an orientation of the hand-held object from the desired orientation based at least in part on the signal indicative of changes in orientation of the hand-held object and the desired orientation; and
a communicative device configured to receive the signal indicative the deviation of the orientation of the hand-held object from the desired orientation and communicate an indication of the deviation of the orientation of the hand-held object from the desired orientation to the user based on the signal.

2. The apparatus of claim 1, wherein the planar, exterior surface is part of a detachable portion of a hand-held tool.

3. The apparatus of claim 2, wherein the detachable portion includes the input device, the orientation sensing device, and the processor.

4. The apparatus of claim 2, wherein the detachable portion of the hand-held tool is a removable battery pack of the hand-held tool, and wherein the planar surface is a bottom surface of the removable battery pack.

5. The apparatus of claim 4, wherein the removable battery pack includes the input device.

6. The apparatus of claim 1, wherein the planar, exterior surface is a fixed part of the hand-held tool.

7. The apparatus of claim 1, wherein the communicative device is a visual display.

8. The apparatus of claim 7, wherein the communicative device is a heads-up display.

9. The apparatus of claim 7, wherein the communicative device is a plurality of LEDs assembled as part of a hand-held tool, wherein the plurality of LEDs are visible to a user during operation of the hand-held tool.

10. The apparatus of claim 1, wherein the communicative device is an audio device.

11. The apparatus of claim 1, wherein the orientation sensing device is any of an accelerometer and a gyroscope.

12. The apparatus of claim 1, wherein the input device is any of a mechanical switch and an optical proximity sensor.

13. A method comprising:
receiving an indication that a planar, exterior surface of a hand-held tool is oriented coplanar with a planar surface of a work piece at a reference orientation;
determining a desired orientation of the hand-held tool relative to the work piece that is different from the reference orientation by applying a coordinate transformation to the reference orientation;
receiving a signal indicative of changes in orientation of the hand-held tool;
generating a signal indicative of a deviation of an orientation of the hand-held tool from the desired orientation based at least in part on the signal indicative of changes in orientation of the hand-held tool and the desired orientation; and
communicating an indication of the deviation of the orientation of the hand-held tool from the desired orientation to a user based on the signal.

14. The method of claim 13, wherein the indication that the planar, exterior surface of the hand-held tool is oriented coplanar with the planar surface of the work piece at the reference orientation is based on a change of state of an electro-mechanical sensor.

15. The method of claim 13, wherein the communicating the indication of the orientation of the hand-held tool relative to the orientation of the work piece involves a visual display.

16. The method of claim 15, wherein the visual display is a heads-up display.

17. The method of claim 15, wherein the visual display is a plurality of LEDs assembled as part of the hand-held tool, wherein the plurality of LEDs are visible to a user during operation of the hand-held tool.

18. The method of claim 13, wherein the planar, exterior surface is part of a detachable portion of the hand-held tool.

19. An apparatus comprising:
a planar, exterior surface;
an input device configured to generate an indication that the planar, exterior surface is oriented coplanar with a planar surface of a work piece at a reference orientation;
an orientation sensing device configured to generate a signal indicative of changes in orientation of a hand-held object manipulated by a user, wherein the planar, exterior surface is coupled to the hand-held object;
a non-transitory, computer-readable medium including,
code for causing a processor to receive the indication of the reference orientation from the input device;
code for causing the processor to determine a desired orientation of the hand-held object relative to the work piece that is different from the reference orientation by applying a coordinate transformation to the reference orientation;
code for causing the processor to receive the signal indicative of changes in orientation of the hand-held object; and
code for causing the processor to generate a signal indicative of a deviation of an orientation of the hand-held object from the desired orientation based at least in part on the signal indicative of changes in orientation of the hand-held object and the desired orientation; and
a communicative device configured to receive the signal indicative of the deviation of the orientation of the hand-held object from the desired orientation and communicate an indication of the deviation of the orientation of the hand-held object from the desired orientation to the user based on the signal.

20. The apparatus of claim 19, wherein the planar, exterior surface is part of a detachable portion of a hand-held tool.
